(19) United States
(12) Patent Application Publication
(10) Pub. No.: US 2023/0311893 A1
(43) Pub. Date: Oct. 5, 2023

(54) VEHICLE AND CONTROL METHOD THEREOF

(71) Applicants: Hyundai Motor Company, Seoul (KR); Kia Corporation, Seoul (KR)

(72) Inventor: Daeyun An, Anyang (KR)

(21) Appl. No.: 18/078,052

(22) Filed: Dec. 8, 2022

(30) Foreign Application Priority Data
Mar. 30, 2022 (KR) 10-2022-0039570

(51) Int. Cl. B60W 30/182; B60W 50/14; G06V 20/56; G06T 7/73; H04W 4/44; G06Q 20/10

(52) U.S. Cl. CPC B60W 30/182; B60W 50/14; G06V 20/56; G06T 7/73; H04W 4/44; G06Q 20/102; B60W 2050/146; B60W 2420/42; B60W 2540/215; B60W 2556/45; G06T 2207/30252

(57) ABSTRACT

Disclosed are a vehicle and a control method thereof. The vehicle control method includes determining whether a current location of the vehicle is a car wash, and activating a car washing-related option preset in the vehicle in preparation for car washing when the current location of the vehicle is the car wash.

### CROSS-REFERENCE TO RELATED APPLICATION(S)

This application is based on and claims priority under 35 U.S.C. § 119 to Korean Patent Application No. 10-2022-0039570, filed on Mar. 30, 2022, in the Korean Intellectual Property Office, the disclosure of which is incorporated by reference herein in its entirety.

### BACKGROUND

### 1. Field

The disclosure relates to a vehicle, and more particularly to an automatic control of a vehicle.

### 2. Description of the Related Art

Automatic car washing is a car washing method in which water supply, foaming, brushing, and the like are automatically performed as a vehicle passes through automatic car washing equipment in a car wash. Depending on the type of automatic car washing equipment, car washing may be performed while the automatic car washing equipment moves in a state where the vehicle is stopped.

In such automatic car washing, various devices of a vehicle need to be controlled to avoid damage to occupants or the vehicle during a washing process. For example, a driver needs to close doors, windows, a sunroof, and the like of the vehicle to prevent water ingress, and needs to turn off a rain sensor linked to wipers to prevent damage to the wipers during a brushing process.

### SUMMARY

It is an aspect of the disclosure to provide a vehicle capable of easily controlling various devices of the vehicle necessary for car washing by determining whether the current location of the vehicle is a car wash and activating car washing-related options collectively and automatically when the current location is the car wash, and a control method thereof.

Additional aspects of the disclosure will be set forth in part in the description which follows and, in part, will be obvious from the description, or may be learned by practice of the disclosure.

In accordance with an aspect of the disclosure, a vehicle control method includes determining whether a current location of the vehicle is at a car wash, and activating a car washing-related option preset in the vehicle in preparation for car washing of the vehicle if the current location of the vehicle is determined to be at the car wash.

The determining of whether the current location of the vehicle is at the car washstep may be performed based on current location information of the vehicle provided by a navigation device of the vehicle.

The determining of whether the current location of the vehicle is the car wash may be performed through analysis of an image taken around the vehicle captured by a camera of the vehicle.

It is determined that the current location of the vehicle is at the car wash if a feature capable of inferring a car wash exists in the image, it may be determined that the current location of the vehicle is the car wash.

The determining of whether the current location of the vehicle is at the car wash step may be performed based on a communication result between a wireless communication device of the vehicle and a wireless payment system of the car wash.

The car washing-related option may include at least one of: i) folding of exterior mirrors, ii) deactivation of parking assist control, iii) deactivation of a rain sensor, iv) deactivation of a rear wiper, v) closing of a sunroof, and vi) closing of windows.

In accordance with another aspect of the disclosure, a vehicle includes a memory storage provided to store a preset car washing-related option in preparation for car washing of the vehicle, and a controller configured to determine whether a current location of the vehicle is at a car wash, and activate the car washing-related option if the current location of the vehicle is at the car wash.

The controller may be further configured to determine whether the current location of the vehicle is the car wash based on current location information of the vehicle provided by a navigation device of the vehicle.

The controller may be further configured to determine whether the current location of the vehicle is at the car wash may be performed through analysis of an image around the vehicle captured by a camera of the vehicle.

If a feature capable of inferring a car wash exists in the image, the controller may be further configured to determine that the current location of the vehicle is at the car wash.

The controller may be further configured to determine whether the current location of the vehicle is at the car wash based on a communication result between a wireless communication device of the vehicle and a wireless payment system of the car wash.

The car washing-related option may include at least one of: I) folding of exterior mirrors, ii) deactivation of parking assist control, iii) deactivation of a rain sensor, iv) deactivation of a rear wiper, v) closing of a sunroof, and vi) closing of windows.

In accordance with another aspect of the disclosure, a vehicle control method includes determining whether a current location of a vehicle is at a car wash, receiving a selection of a car washing mode of the vehicle if the current location of the vehicle is at the car wash, and activating a car washing-related option preset in the vehicle in preparation for car washing of the vehicle if the selection of the car washing mode is received.

The receiving of the selection of the car washing mode step may include asking a question whether to switch to the car washing mode through a display device, and receiving a response of a user to the question.

The car washing-related option may include at least one of: i) folding of exterior mirrors, ii) deactivation of parking assist control, iii) deactivation of a rain sensor, iv) deactivation of a rear wiper, v) closing of a sunroof, and vi) closing of windows.

In accordance with another aspect of the disclosure, a vehicle control method includes determining whether a current location of a vehicle is at a car wash, providing a payment service in the vehicle for payment of a car washing fee if the current location of the vehicle is at the car wash, and activating a car washing-related option preset in the vehicle in preparation for car washing of the vehicle if the payment of the car washing fee is completed.

The providing of the payment service in the vehicle step may be performed through communication between a wireless communication device provided in the vehicle and a wireless payment system of the car wash.

The car washing-related option may include at least one of i) folding of exterior mirrors, ii) deactivation of parking assist control, iii) deactivation of a rain sensor, iv) deactivation of a rear wiper, v) closing of a sunroof, and vi) closing of windows.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates a block diagram of a control system of a vehicle according to an embodiment of the disclosure;

FIG. 2 illustrates a flowchart of a vehicle control method according to a first embodiment of the disclosure;

FIG. 3 illustrates an example of a dialog box displayed on a display device in the first embodiment of the disclosure;

FIG. 4 illustrates a flowchart of a vehicle control method according to a second embodiment of the disclosure;

FIG. 5 illustrates an example of a dialog box displayed on the display device in the second embodiment of the disclosure;

FIG. 6 illustrates another example of a dialog box displayed on the display device in the second embodiment of the disclosure:

FIG. 7 illustrates a flowchart of a vehicle control method according to a third embodiment of the disclosure; and

FIG. 8 illustrates an example of a dialog box related to payment displayed on the display device in the third embodiment of the disclosure.

### DETAILED DESCRIPTION

Throughout the specification, like reference numerals refer to like elements. This specification does not describe all the elements of the embodiments, and duplicative contents between general contents or embodiments in the technical field of the present disclosure will be omitted. The terms “part,” “module,” “member,” and “block” as used herein, may be implemented as software or hardware, and according to embodiments, a plurality of “parts,” “modules,” “members,” or “blocks” may be implemented as a single component, or a single “part,” “module,” “member,” or “block” may include a plurality of components.

Throughout the specification, when a portion is “connected” to another portion, this includes the case in which the portion is indirectly connected to the other portion, as well as the case in which the portion is directly connected to the other portion, and the indirect connection includes a connection through a wireless communication network.

When a part “includes” a certain component, it means that other components may be further included, rather than excluding other components, unless otherwise stated.

In the present specification, it will also be understood that when an element is referred to as being “on” or “over” another element, this may include not only a case in which an element is in contact with another element but also a case in which another element exists between the two elements.

The terms first, second, etc. are used to distinguish one component from another component, and the component is not limited by the above-mentioned terms.

The singular expression includes the plural expression unless the context clearly dictates otherwise.

Identification numerals assigned to steps are used to identify the steps, the identification numerals do not indicate the order of the steps, and each step may be performed differently from the specified order unless the context clearly indicates a specific order.

Hereinafter, an operation principle and embodiments of the disclosure will be described with reference to the accompanying drawings.

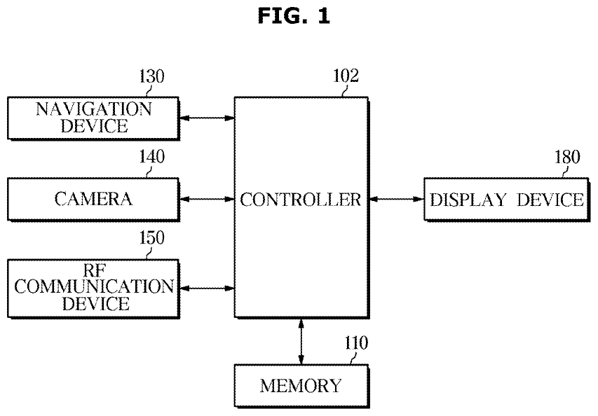

FIG. 1 illustrates a block diagram of a control system of a vehicle according to an embodiment of the disclosure.

As illustrated in FIG. 1, a memory 110, a navigation device 130, a camera 140, an RF communication device 150, and a display device 180 are communicatively connected to a controller 102. The controller 102 may be an electronic control unit for controlling an operation of a vehicle. The memory 110 may store software and data that is used by the controller 102 to control the vehicle. The navigation device 130 is provided to guide a route to a driver. The camera 140 is provided to capture the surroundings of the vehicle. The RF communication device 150, which is a wireless communication device, is provided to perform RF communication. In the vehicle according to an embodiment of the disclosure, the RF communication device 150 performs RF communication with a payment system of a gas station or a payment system of a car wash so that the driver of the vehicle may use a payment service. The display device 180 is provided to display information to be provided to the driver. The controller 102 may control the display device 180 to display a setting and selection related to a car washing mode, various graphic interfaces for selection and use of a vehicle payment service, a dialog box, and the like. At least one component may be added or deleted depending on the performance of the components of the vehicle illustrated in FIG. 1. In addition, it will be readily understood by those skilled in the art that the mutual positions of the components may be changed depending on the performance or structure of the system. Each component illustrated in FIG. 1 refers to software and/or a hardware component such as a field programmable gate array (FPGA) and an application specific integrated circuit (ASIC).

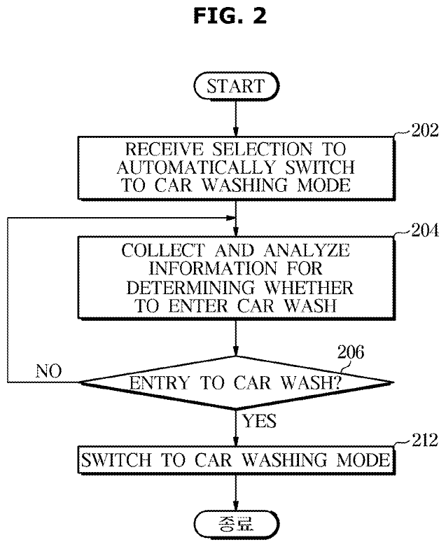

FIG. 2 illustrates a flowchart of a vehicle control method according to a first embodiment of the disclosure.

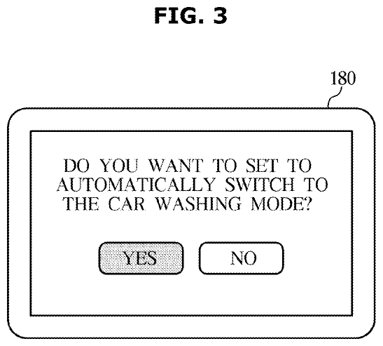

As illustrated in FIG. 2, the controller 102 receives a selection of a user to automatically switch the vehicle to the car washing mode (202). To this end, the controller 102 displays a question such as “Do you want to set to automatically switch to the car washing mode?” in a dialog box as illustrated in FIG. 3 on the display device 180, and receives the selection of the user for this display.

FIG. 3 illustrates an example of a dialog box displayed on a display device in the first embodiment of the disclosure. In FIG. 3, when the driver selects “YES”, the controller 102 automatically switches the vehicle to the car washing mode when a preset car washing mode entry condition is satisfied, and activates car washing-related options set for the car washing mode. The carwashing-related options are listed below. The car washing-related options are not limited to those described below, and may further include several other options that require actions when the vehicle is washed.
i) Folding of exterior mirrors
ii) Deactivation of parking assist control
iii) Deactivation of a rain sensor
iv) Deactivation of a rear wiper
v) Closing of a sunroof
vi) Closing of windows

That is, in an embodiment of the disclosure, when the vehicle is switched to the car washing mode, the options necessary for car washing, such as those described above, are automatically performed to prevent damage to the vehicle during car washing.

Returning to FIG. 2, in a state in which the selection of the user for automatically switching to the car washing mode is received, the controller 102 collects and analyzes information for determining whether the vehicle enters the car wash (204). In the first embodiment of the disclosure, when it is determined that the vehicle has entered the car wash, the controller 102 automatically switches the vehicle to the car washing mode. To this end, the controller 102 determines whether the vehicle enters the car wash by collecting and analyzing information necessary to determine whether the vehicle enters the car wash. The collection and analysis of information for determining whether the vehicle enters the car wash may be performed as follows.

First, the controller 102 may determine whether the vehicle enters the car wash by using current location guidance information of the navigation device 130. That is, when the information on the current location of the vehicle provided by the navigation device 130 points to a place registered as the car wash, the controller 102 may determine that the vehicle is currently located in the car wash.

Alternatively, the controller 102 may determine whether the vehicle enters the car wash through analysis of an image captured by the camera 140. The car wash is equipped with a unique facility for automatic car washing of a vehicle, a registered name, a notice (character string), etc. The unique facility may be, for example, in the shape of a tunnel (or gantry) through which a vehicle is washed while passing therethrough. Because the registered name of the car wash may include a character string such as ‘car washing’ or ‘Car Wash’, through this, it may be determined that the current location of the vehicle is the car wash. In addition, because the car wash may have a notice that guides the driver on a necessary action before starting car washing, such as ‘Raise all the windows’ and ‘Turn off the engine’, also through this, it may be determined that the current location of the vehicle is the car wash. As such, the controller 102 may check whether a unique facility, a registered name, a notice (character string), etc., that allow the driver to know that it is the car wash are included in the image captured by the camera 140 in the vehicle, and through this, determine that the current location of the vehicle is the car wash.

Alternatively, the controller 102 may determine that the current location of the vehicle is the car wash using a communication result of the RF communication device 150. For example, the controller 102 may communicate with a wireless payment system provided in the car wash through the RF communication device 150 provided in the vehicle, and the registered name of the place where the vehicle is currently located is exposed through this communication, the controller 102 may confirm that the current location is the car wash from the registered name of the current location exposed in the process of this communication.

The controller 102 may determine whether the vehicle enters the car wash using all of the navigation device 130, the camera 140, and the RF communication device 150, using only any two of them, or using only any one of them.

When it is determined that the vehicle has entered the car wash (206: YES), the controller 102 switches the vehicle to the preset car washing mode (212). In step 202 above, the controller 102 has set the vehicle to be automatically switched to the car washing mode when the preset car washing mode entry condition is satisfied by the driver selecting “YES” in the dialog box of FIG. 3. Therefore, because it is determined that the vehicle is currently located in the car wash, the controller 102 switches the vehicle to the car washing mode so that the car washing-related options, such as i) folding of the exterior mirrors, ii) deactivation of the parking assist control, iii) deactivation of the rain sensor, iv) deactivation of the rear wiper, v) closing of the sunroof, and vi) closing of the windows, are activated.

As such, in the vehicle according to an embodiment of the disclosure, because the car washing is performed in a state where the car washing-related options are automatically and collectively activated, the driver of the vehicle does not need to manually activate the various options for the car washing mode, which greatly increases the convenience of the driver of the vehicle.

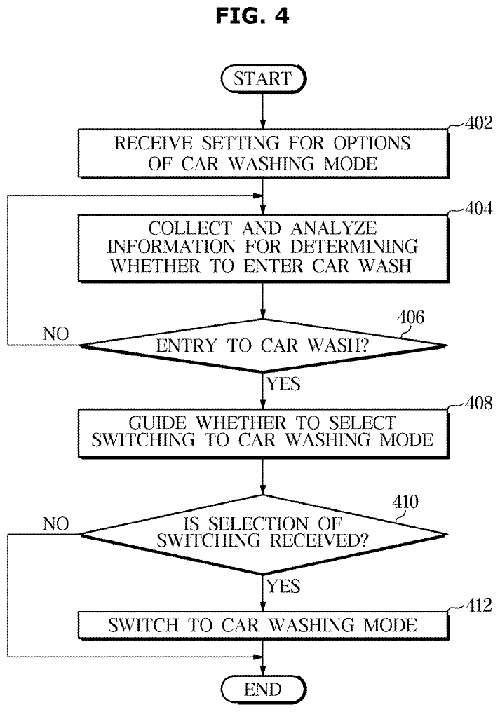

FIG. 4 illustrates a flowchart of a vehicle control method according to a second embodiment of the disclosure.

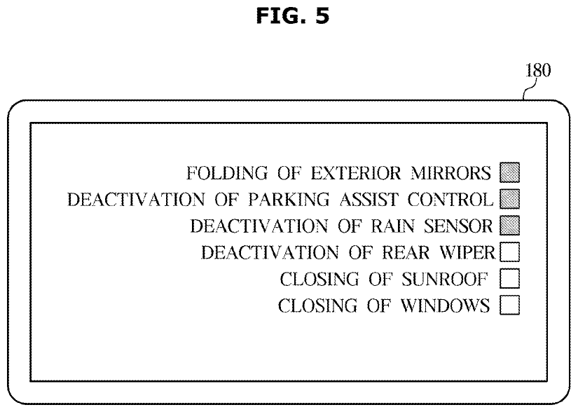

As illustrated in FIG. 4, the controller 102 receives a setting of the user for the options related to the car washing mode of the vehicle (402). To this end, the controller 102 displays the options related to the car washing mode as illustrated in FIG. 5 on the display device 180, and receives the selection (activation) of the user for this display. FIG. 5 illustrates an example of a dialog box displayed on the display device in the second embodiment of the disclosure. In an embodiment of the disclosure, the options related to the car washing mode that may be selectively activated by the user are, for example, as follows. The user may select some or all of these options, and prepare for a car washing situation by activating the options selected by the user when the vehicle is switched to the car washing mode. The car washing-related options are not limited to those described below, and may further include several other options that require actions when the vehicle is washed.
i) Folding of the exterior mirrors
ii) Deactivation of the parking assist control
iii) Deactivation of the rain sensor
iv) Deactivation of the rear wiper
v) Closing of the sunroof
vi) Closing of the windows

That is, in an embodiment of the disclosure, when the vehicle is switched to the car washing mode, the options necessary for car washing, such as those described above, are automatically performed to prevent damage to the vehicle during car washing.

Returning to FIG. 4, in a state in which the option setting of the car washing mode is completed, the controller 102 collects and analyzes information for determining whether the vehicle enters the car wash (404). In the second embodiment of the disclosure, when it is determined that the vehicle has entered the car wash, the controller 102 switches the vehicle to the car washing mode only when the user selects after confirmation of the user. To this end, the controller 102 determines whether the vehicle enters the car wash by collecting and analyzing information necessary to determine whether the vehicle enters the car wash. The collection and analysis of information for determining whether the vehicle enters the car wash may be performed as follows.

First, the controller 102 may determine whether the vehicle enters the car wash by using current location guidance information of the navigation device 130. That is, when the information on the current location of the vehicle provided by the navigation device 130 points to a place registered as the car wash, the controller 102 may determine that the vehicle is currently located in the car wash.

Alternatively, the controller 102 may determine whether the vehicle enters the car wash through analysis of an image captured by the camera 140. The car wash is equipped with a unique facility for automatic car washing of a vehicle, a registered name, a notice (character string), etc. The unique facility may be, for example, in the shape of a tunnel (or gantry) through which a vehicle is washed while passing therethrough. Because the registered name of the car wash may include a character string such as ‘car washing’ or ‘Car Wash’, through this, it may be determined that the current location of the vehicle is the car wash. In addition, because the car wash may have a notice that guides the driver on a necessary action before starting car washing, such as ‘Raise all the windows’ and ‘Turn off the engine’, also through this, it may be determined that the current location of the vehicle is the car wash. As such, the controller 102 may check whether a unique facility, a registered name, a notice (character string), etc., that allow the driver to know that it is the car wash are included in the image captured by the camera 140 in the vehicle, and through this, determine that the current location of the vehicle is the car wash.

Alternatively, the controller 102 may determine that the current location of the vehicle is the car wash using the communication result of the RF communication device 150. For example, the controller 102 may communicate with the wireless payment system provided in the car wash through the RF communication device 150 provided in the vehicle, and the registered name of the place where the vehicle is currently located is exposed through this communication, the controller 102 may confirm that the current location is the car wash from the registered name of the current location exposed in the process of this communication.

The controller 102 may determine whether the vehicle enters the car wash using all of the navigation device 130, the camera 140, and the RF communication device 150, using only any two of them, or using only any one of them.

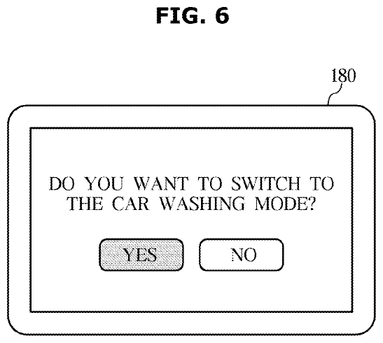

When it is determined that the vehicle has entered the car wash (406: YES), the controller 102 guides the driver whether to select switching to the car washing mode (408). To this end, the controller 102 may display a dialog box as illustrated in FIG. 6. FIG. 6 illustrates another example of a dialog box displayed on the display device in the second embodiment of the disclosure. In FIG. 6, when the driver selects “YES”, the controller 102 switches the vehicle to the car washing mode.

When the selection of switching to the car washing mode by the user is received (410: YES), the controller 102 switches the vehicle to the preset car washing mode (412). In step 402 above, by the driver selecting some or all of the various options displayed in the dialog box of FIG. 5, the controller 102 has set to activate the options selected by the user when switching to the car washing mode. Therefore, because it is determined that the vehicle is currently located in the car wash and the driver has selected to switch to the car washing mode, the controller 102 switches the vehicle to the car washing mode so that the options selected by the user among the car washing-related options, such as i) folding of the exterior mirrors, ii) deactivation of the parking assist control, iii) deactivation of the rain sensor, iv) deactivation of the rear wiper, v) closing of the sunroof, and vi) closing of the windows, are activated.

As such, in the vehicle according to an embodiment of the disclosure, because when it is determined that the vehicle is located in the car wash, the car washing is performed in a state where the options selected for the car washing mode are automatically and collectively activated, the driver of the vehicle does not need to manually activate the various options for the car washing mode every time the driver visits the car wash, which greatly increases the convenience of the driver of the vehicle. In addition, after determining that the current location of the vehicle is the car wash, the controller 102 performs an additional confirmation process for switching to the car washing mode from the driver and then switches to the car washing mode, thereby more reliably securing the basis for switching to the car washing mode.

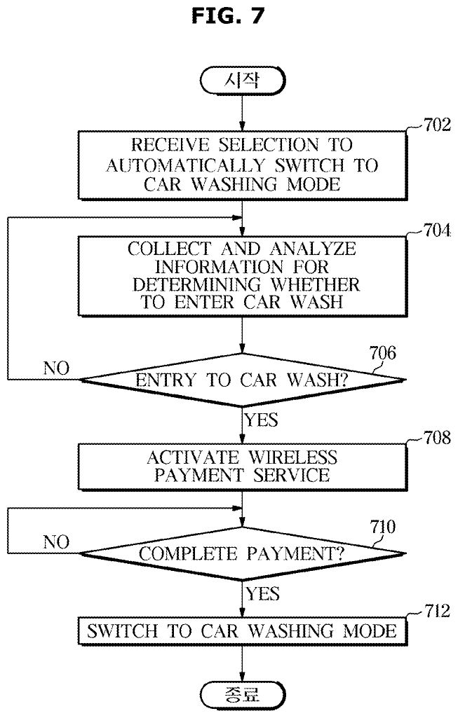

FIG. 7 illustrates a flowchart of a vehicle control method according to a third embodiment of the disclosure.

As illustrated in FIG. 7, the controller 102 receives the setting of the user to automatically switch the vehicle to the car washing mode (702). To this end, the controller 102 displays the question such as “Do you want to set to automatically switch to the car washing mode?” in the dialog box as illustrated in FIG. 3, which has been described above, on the display device 180, and receives the selection of the user for this display. FIG. 3 illustrates an example of the dialog box displayed on the display device in the first embodiment of the disclosure. In FIG. 3, when the driver selects “YES”, the controller 102 automatically switches the vehicle to the car washing mode when a preset car washing mode entry condition is satisfied, and activates the car washing-related options set for the car washing mode. The car washing-related options are listed below. The car washing-related options are not limited to those described below, and may further include several other options that require actions when the vehicle is washed.
i) Folding of the exterior mirrors
ii) Deactivation of the parking assist control
iii) Deactivation of the rain sensor
iv) Deactivation of the rear wiper
v) Closing of the sunroof
vi) Closing of the windows

That is, in an embodiment of the disclosure, when the vehicle is switched to the car washing mode, the options necessary for car washing, such as those described above, are automatically performed to prevent damage to the vehicle during car washing.

Returning to FIG. 7, in the state in which the selection of the user for automatically switching to the car washing mode is received, the controller 102 collects and analyzes information for determining whether the vehicle enters the car wash (704). In the third embodiment of the disclosure, when it is determined that the vehicle has entered the car wash, the controller 102 performs payment by accessing the wireless payment service of the car wash through the RF communication device 150, and when the payment is completed, the controller 102 automatically switches the vehicle to the car washing mode. To this end, the controller 102 determines whether the vehicle enters the car wash by collecting and analyzing information necessary to determine whether the vehicle enters the car wash. The collection and analysis of information for determining whether the vehicle enters the car wash may be performed as follows.

First, the controller 102 may determine whether the vehicle enters the car wash by using the current location guidance information of the navigation device 130. That is, when the information on the current location of the vehicle provided by the navigation device 130 points to a place registered as the car wash, the controller 102 may determine that the vehicle is currently located in the car wash.

Alternatively, the controller 102 may determine whether the vehicle enters the car wash through analysis of the image captured by the camera 140. The car wash is equipped with a unique facility for automatic car washing of a vehicle, a registered name, a notice (character string), etc. The unique facility may be, for example, in the shape of a tunnel (or gantry) through which a vehicle is washed while passing therethrough. Because the registered name of the car wash may include a character string such as ‘car washing’ or ‘Car Wash’, through this, it may be determined that the current location of the vehicle is the car wash. In addition, because the car wash may have a notice that guides the driver on a necessary action before starting car washing, such as ‘Raise all the windows’ and ‘Turn off the engine’, also through this, it may be determined that the current location of the vehicle is the car wash. As such, the controller 102 may check whether a unique facility, a registered name, a notice (character string), etc., that allow the driver to know that it is the car wash are included in the image captured by the camera 140 in the vehicle, and through this, determine that the current location of the vehicle is the car wash.

Alternatively, the controller 102 may determine that the current location of the vehicle is the car wash using the communication result of the RF communication device 150. For example, the controller 102 may communicate with the wireless payment system provided in the car wash through the RF communication device 150 provided in the vehicle, and the registered name of the place where the vehicle is currently located is exposed through this communication, the controller 102 may confirm that the current location is the car wash from the registered name of the current location exposed in the process of this communication.

The controller 102 may determine whether the vehicle enters the car wash using all of the navigation device 130, the camera 140, and the RF communication device 150, using only any two of them, or using only any one of them.

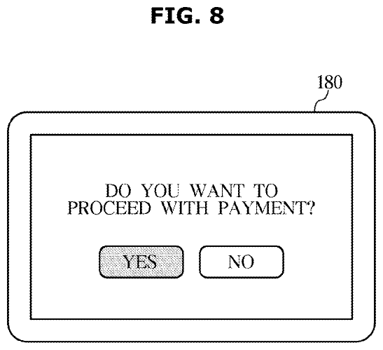

When it is determined that the vehicle has entered the car wash (706: YES), the controller 102 activates the wireless payment service through the RF communication device 150 of the vehicle (708). At this time, the controller 102 receives the selection of the driver as to whether to allow payment using the wireless payment service to be performed by displaying a dialog box as illustrated in FIG. 8 on the display device 180 (710). FIG. 8 illustrates an example of a dialog box related to payment displayed on the display device in the third embodiment of the disclosure. As illustrated in FIG. 8, the controller 102 displays a question such as “Do you want to proceed with payment?” on the display device 180, and performs payment through the wireless payment service when the driver selects “YES”.

Returning to FIG. 7, when payment of a car washing fee through the wireless payment service is completed (710: YES), the controller 102 switches the vehicle to the preset car washing mode (712). In step 702 above, the controller 102 has set the vehicle to be automatically switched to the car washing mode when the preset car washing mode entry condition is satisfied by the driver selecting “YES” in the dialog box of FIG. 3. Therefore, because it is determined that the vehicle is currently located in the car wash, the controller 102 switches the vehicle to the car washing mode so that the car washing-related options, such as i) folding of the exterior mirrors, ii) deactivation of the parking assist control, iii) deactivation of the rain sensor, iv) deactivation of the rear wiper, v) closing of the sunroof, and vi) closing of the windows, are activated.

As such, in the vehicle according to an embodiment of the disclosure, because the car washing is performed in the state where the car washing-related options are automatically and collectively activated, the driver of the vehicle does not need to manually activate the various options for the car washing mode, which greatly increases the convenience of the driver of the vehicle. In addition, in paying the car washing fee before the car washing starts, because the payment is made by connecting to the wireless payment system of the car wash through the RF communication device 150, this also greatly increases the convenience of the driver.

As is apparent from the above, according to the embodiments described above, various devices of a vehicle necessary for car washing can be easily controlled by determining whether the current location of the vehicle is a car wash and activating car washing-related options collectively and automatically when the current location is the car wash.

The disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

The embodiments disclosed with reference to the accompanying drawings have been described above. It will be understood by those skilled in the art that various changes in form and details may be made therein without departing from the spirit and scope of the disclosure as defined by the appended claims. The disclosed embodiments are illustrative and should not be construed as limiting.

What is claimed is:

1. A vehicle control method, comprising:
determining whether a current location of a vehicle is at a car wash; and
activating a car washing-related option preset in the vehicle in preparation for car washing of the vehicle if the current location of the vehicle is determined to be at the car wash.

2. The vehicle control method according to claim 1, wherein the determining of whether the current location of the vehicle is at the car wash step is performed based on current location information of the vehicle provided by a navigation device of the vehicle.

3. The vehicle control method according to claim 1, wherein the determining of whether the current location of the vehicle is at the car wash step further comprises:
performing analysis of an image taken around the vehicle captured by a camera of the vehicle.

4. The vehicle control method according to claim 3, wherein it is determined that the current location of the vehicle is at the car wash if a feature capable of inferring a car wash exists in the image.

5. The vehicle control method according to claim 1, wherein the determining of whether the current location of the vehicle is at the car wash step is performed based on a communication result between a wireless communication device of the vehicle and a wireless payment system of the car wash.

6. The vehicle control method according to claim 1, wherein the car washing-related option comprises at least one of: i) folding of exterior mirrors, ii) deactivation of parking assist control, iii) deactivation of a rain sensor, iv) deactivation of a rear wiper, v) closing of a sunroof, and vi) closing of windows.

7. A vehicle, comprising:
a memory storage configured to store a preset car washing-related option in preparation for car washing; and
a controller configured to:
determine whether a current location of the vehicle is at a car wash, and
activate the car washing-related option if the current location of the vehicle is at the car wash.

8. The vehicle according to claim 7, wherein the controller is further configured to determine whether the current location of the vehicle is at the car wash based on current location information of the vehicle provided by a navigation device of the vehicle.

9. The vehicle according to claim 7, wherein the controller is further configured to determine whether the current location of the vehicle is at the car wash through analysis of an image around the vehicle captured by a camera of the vehicle.

10. The vehicle according to claim 9, wherein if a feature capable of inferring a car wash exists in the image, the controller is further configured to determine that the current location of the vehicle is at the car wash.

11. The vehicle according to claim 7, wherein the controller is further configured to determine whether the current location of the vehicle is at the car wash based on a communication result between a wireless communication device of the vehicle and a wireless payment system of the car wash.

12. The vehicle according to claim 7, wherein the car washing-related option comprises at least one of: i) folding of exterior mirrors, ii) deactivation of parking assist control, iii) deactivation of a rain sensor, iv) deactivation of a rear wiper, v) closing of a sunroof, and vi) closing of windows.

13. A vehicle control method, comprising:
determining whether a current location of a vehicle is at a car wash;
receiving a selection of a car washing mode of the vehicle when the current location of the vehicle is at the car wash; and
activating a car washing-related option preset in the vehicle in preparation for car washing of the vehicle if the selection of the car washing mode is received.

14. The vehicle control method according to claim 13, wherein the receiving of the selection of the car washing mode step further comprises:
asking a question whether to switch to the car washing mode through a display device, and
receiving a response to the question.

15. The vehicle control method according to claim 13, wherein
the car washing-related option comprises at least one of i) folding of exterior mirrors, ii) deactivation of parking assist control, iii) deactivation of a rain sensor, iv) deactivation of a rear wiper, v) closing of a sunroof, and vi) closing of windows.

16. The vehicle control method according to claim 1, further comprising:
providing a payment service in the vehicle for payment of a car washing fee when the current location of the vehicle is at the car wash, and
wherein the activating a car washing-related option preset in the vehicle is performed after the payment service is completed.

17. The vehicle control method according to claim 16, wherein the providing of the payment service in the vehicle step is performed through communication between a wireless communication device provided in the vehicle and a wireless payment system of the car wash.

18. The vehicle control method according to claim 16, wherein the car washing-related option comprises at least one of: i) folding of exterior mirrors, ii) deactivation of parking assist control, iii) deactivation of a rain sensor, iv) deactivation of a rear wiper, v) closing of a sunroof, and vi) closing of windows.
